(19) United States
(12) Patent Application Publication
(10) Pub. No.: US 2016/0006684 A1
(43) Pub. Date: Jan. 7, 2016

(54) COMMUNICATION SYSTEM, CONTROL APPARATUS, COMMUNICATION METHOD, AND PROGRAM

(71) Applicant: NEC Corporation, Tokyo (JP)

(72) Inventor: Ippei Akiyoshi, Tokyo (JP)

(21) Appl. No.: 14/770,144

(22) PCT Filed: Feb. 25, 2014
(86) PCT No.: PCT/JP2014/054485

§ 371 Date: Aug. 25, 2015

(30) Foreign Application Priority Data
Feb. 26, 2013 (JP) 2013-036090

(51) Int. Cl. H04L 29/12; H04L 12/741; H04L 12/761

(52) U.S. Cl. CPC H04L 61/103; H04L 45/16; H04L 45/74

(57) ABSTRACT

A control apparatus is configured to generate a processing rule that defines packet processing in a communication apparatus and set the processing rule in the communication apparatus, to determine one or more logical networks for broadcast targets, based on correspondence relationship between network address and logical network, to obtain one or more communication apparatuses connected to the determined one or more logical networks and to set the one or more communication apparatuses to perform broadcast transmission to the determined one or more logical networks.

### REFERENCE TO RELATED APPLICATION

This application is based upon and claims the benefit of the priority of Japanese Patent Application No. 2013-036090 filed on Feb. 26, 2013, the disclosure of which is incorporated herein in its entirety by reference thereto.

### TECHNICAL FIELD

The present invention relates to a communication system, a control apparatus, a communication method, and a program. More specifically, the invention relates to a communication system, a control apparatus, a communication method, and a program suitable for being applied to a network to be controlled by the control apparatus.

### BACKGROUND

In recent years, a network architecture of a centralized control type is proposed. As an example of the network architecture of the centralized control type, there is provided a technology called OpenFlow (refer to Patent Literature 1 and Non Patent Literatures 1 and 2).

### <OpenFlow (OpenFlow)>

OpenFlow treats communication as end-to-end flow, and performs path control, malfunction recovery, load balancing, optimization, and so forth on a per flow basis. Specifications and so forth of an OpenFlow switch (OpenFlow Switch: abbreviated as “OFS”) are referred to in Non Patent Literature 2 and so on, for example. OpenFlow switch communicates with OpenFlow controller (OpenFlow Controller: abbreviated as “OFC”) corresponding to a control apparatus, using, for example, a secure channel for communication. An OFS includes a flow table in which appropriate adding or rewriting is instructed by an OFC, and operates according to content of the flow table.

### <OFS and Flow Table>

FIG. 8 is a diagram schematically illustrating one flow entry 120 of a flow table. In the flow table, a set of a matching rule (match field: Match Field) (header field) to be matched against a header of a packet received by an OFS, flow statistical information (Counters), actions (Actions or Instructions) defining processing content is defined for each flow.

When an OFS receives a packet, the OFS searches a flow table for an entry having a matching rule that matches header information of the received packet. When the entry that matches the received packet is found as a result of the search of the flow table, the OFS updates the flow statistical information (one or more Counters), and executes, for the received packet, the processing content (e.g., transmission of a packet from a specified port, flooding of a packet, discarding of a packet, or the like) described in the field of actions (Actions) of the entry.

### <Packet In>

On the other hand, when an entry that matches the received packet is not found in the OFS as a result of the search, the OFS forwards the received packet (through a Packet In message) to an OFC via a secure channel and requests determination of a path for the packet based on information of a transmission source and a transmission destination of the received packet. The OFC calculates a path based on network topology information, generates a flow entry (in FIG. 8), and transmits a message (Flow Modify (FlowModify) message) for updating the flow table to each OFS on the calculated path. The OFS receives, from the OFC, information on an flow entry associated with the path for the packet determined by the OFC and updates the flow table. In this way, the OFS processes the received packet by using the information on the flow entry stored in the flow table as a processing rule.

There has been studied a communication system which executes network control to mix L2/L3 (layer 2/3) forwarding in accordance with the OSI (Open System Interconnection) reference model, using OpenFlow. An example of this network control will be described below with reference to FIGS. 9 to 13.

Referring to FIG. 9, this communication system (that is an example of a prototype) includes an OFC 110, OFSs 121 to 123, and communication terminals 131-1, 131-2, and 132. Numerals (1 in FIG. 9) described beside lines between the communication terminals and the OFSs indicate numbers of ports of the OFSs to which the communication terminals are connected. The OFC 110 manages information illustrated in FIGS. 10 and 11 in order to implement L3 forwarding.

### <Logical Network Management Information Table>

FIG. 10A illustrates an information table for management of logical networks that are managed on the communication system. Each logical network is a network associated with a subnet, and is defined by a port group to which one or more of communication terminals are connected. As illustrated in FIG. 10A, each logical network is defined by one or more OFSs and one or more port numbers. A logical network 141 in FIG. 9 is defined by port number 1 of OFS 121 and port number 1 of OFS 122. A logical network 142 is defined by port number 1 of OFS 123. A different parameter such as a VLAN (Virtual Local Area Network) may be additionally used for definition of a logical network. Though no particular limitation is imposed, the table in FIG. 10A is managed by OFC 110, for example.

### <Location Management Information Table>

FIG. 10B illustrates an information table for location management, and illustrates information on the communication terminals managed on the communication system illustrated in FIG. 9. In an example illustrated in FIG. 10B, a granularity for managing location information, a MAC (Media Access Control) address is used. Further, in association with the location information (MAC address), OFS and a port number of the OFS are used. The information on the communication terminals in FIG. 10B is managed by OFC 110, for example.

### <Routing Management Information Table>

FIG. 11A illustrates routing information (L3 routing management information) managed on the communication system in FIG. 9. The table in FIG. 11A may be managed by OFC 110. This table stores and manages a correspondence relationship between each subnet and a logical network associated with the subnet. A numeral in a portion “/24” on a right side of an IP (Internet Protocol) address: “192.168.1.0”, such as “192.168.1.0/24”, for example, is a subnet mask value, and indicates that upper 24 bits of the IP address constitute a network address part (in CIDR (Classless Inter-Domain Routing) notation). In FIG. 11A, all subnets are associated with logical networks, as routing information. It is noted that a subnet associated with a router may be provided. FIG. 17 is a table for explaining a subnet associated with a router. Referring to FIG. 17, a subnet of “192.168.100.0/24” is associated with a gateway with an IP address of “192.168.3.1”. When the table in FIG. 17 is searched to determine a forwarding destination of a packet addressed to a subnet of “192.168.100.1”, it can be seen that the packet first needs to be forwarded to a destination with an IP address of “192.168.3.1”. Then, when the table in FIG. 17 is searched again to search a logical network in which an IP address of “192.168.3.1” is present, it can be seen that the IP address of “192.168.3.1” belongs to a logical network 143 (associated with the subnet of “192.168.3.0/24”).

<ARP Cache (ARP table)>

FIG. 11B illustrates ARP (Address Resolution Protocol) cache information (ARP table) for each communication terminal managed on the communication system. Herein, a correspondence relationship between a MAC address obtained from a response (ARP reply) for an ARP request and an IP address associated with the MAC address (IP address and MAC address of the communication terminal) is managed.

### <Default Gateway>

OFC is configured to manage a MAC address associated with an address of a default gateway that is set in each logical network in order to implement L3 forwarding. Values obtained respectively by masking an IP address of a node belonging to a logical network and an IP address of the default gateway by a subnet mask, assume a same value and belong to the same logical network.

### <L3 Routing>

Even if communication terminals are physically connected to a same switch (L2 switch), direct L2 communication cannot be performed, when logical networks are different (subnets are different). The different logical networks (different subnets) have different broadcast domains (broadcasting range). That is, referring to FIG. 9, for example, a frame cannot be directly sent from a subnet “192. 168. 1. 0/24” to a subnet “192. 168. 2. 0/24”. Thus, packet communication needs to be performed via a default gateway using L3 (IP address) (L3 routing becomes necessary). Broadcasting (broadcasting) is used for simultaneously transmitting information (packets) to all apparatuses (hosts, nodes, or communication terminals) connected to a network (subnet) without specifying an apparatus (host, node, or communication terminal) of a destination.

### <Address Resolution Protocol (ARP)>

An ARP is a protocol for obtaining a MAC address using an IP address. A destination (Destination) MAC address of an apparatus of the other party is necessary in the end in order to perform communication with the other party. However, when logical networks (subnets) of a source and a destination are different, an ARP request does not directly reach the different logical network. As a result, direct L2 communication cannot be performed. Thus, L3 routing becomes necessary. That is, an ARP request is transmitted as an L2 broadcast frame. However, when a logical network (subnet) of the destination is different from that of the source, a broadcast domain is divided, so that an ARP request does not directly reach the destination. For this reason, OFC that simulates routing between different logical networks (subnets) becomes an default gateway. ARP request is broadcast to the different logical network through this default gateway (OFC). FIG. 16 is a diagram schematically illustrating an ARP format. As illustrated in FIG. 16, a destination MAC address (DST ADDR) of an Ethernet (registered trademark) header portion is set to a broadcast address (of all 1s of 6 bytes (48 bits) and FF-FF-FF-FF-FF-FF in hexadecimal (Hexadecimal) notation), and a type (TYPE) is set to 0x0806 (where 0x indicates a Hexadecimal (hexadecimal) notation). FIG. 16 illustrates Ethernet (registered trademark) header portion constituting an OpenFlow header portion. ARP frame format provided at a data portion between Ethernet (registered trademark) header and CRC (Cyclic Redundancy Check: 4 bytes) is constituted from a hardware type (HW TYPE) (fixed at 1: 2 bytes in Ethernet (registered trademark)), a protocol type (PROTOCOL TYPE) (fixed at 0x0800: 2 bytes), a hardware length (HW LENGTH) (MAC address length is fixed at 6: 1 byte), a protocol length (PROTOCOL LENGTH) (IP address (IPv4 length: fixed at 4: 1 byte), an operation (OPERATION) (for identifying an ARP request or an ARP reply, the ARP request being 1, and the ARP reply being 2), a transmission source MAC address (SRC HW ADDR), a transmission source IP address (SRC Protocol ADDR), a destination MAC address (DST HW ADDR), and a destination IP address (DST Protocol ADDR). The destination MAC address (DST HW ADDR) is indicated by 0x00-000-00-00-00, or FF-FF-FF-FF-FF-FF in an ARP request. DST HW ADDR indicates a destination MAC address in an ARP reply. With respect to a destination IP address (DST Protocol ADDR), when an IP address of a node (host) that has received a broadcast ARP request is identical to this destination IP address, the node determines that a MAC address of the node itself is inquired, sets the MAC address of the node itself in an ARP reply, and then transmits the ARP reply.

In layers 2 and 3 (L2 and L3) of the OSI reference model, a distinction is made between a frame and a packet. In this specification, however, a data unit to be forwarded is referred to a packet.

<Intra-Logical Network Communication (Communication within Same Subnet)>

An operation example of network control in FIG. 9 will be described, with reference to FIGS. 12 and 13. FIG. 12 illustrates path control processing when communication within a logical network (communication between communication terminals 131-1 and 131-2) is performed. A number in parentheses appended to an end of each sentence that explains processing corresponds to a number of a representative sequence schematically illustrated in FIG. 12.

Referring to FIG. 12, the communication terminal 131-1 transmits an ARP request (packet) for MAC address resolution of the communication terminal 131-2 in order to transmit a packet to the communication terminal 131-2 (1).

The OFS 121 receives the packet of the ARP request. The forwarding flow of the ARP request packet is not registered in the flow table of the OFS 121, and is a new flow. For this reason, the OFS 121 transmits a Packet-In message to the OFC 110 (2) and requests the OFC 110 (2) to perform path setting for the ARP request packet received by the OFS 121.

The OFC 110 confirms that the received ARP request packet is an ARP request for MAC address resolution within the logical network (subnet) that is the same as the logical network to which the communication terminal 131-1 belongs, based on the followings:
a destination MAC address of a header of the ARP request packet is a broadcast address;
a destination IP address of an ARP frame (destination IP address for obtaining the destination MAC address) is not that of a default gateway.

The OFC 110 transmits a packet-out (Packet-Out) message to the OFS 122, using management information for the logical networks illustrated in FIG. 10A (where there is stored management information which indicates that port number 1 of the OFS 122 is connected to a logical network 141 of the communication terminal 131-1 to which port number 1 of the OFS 121 is connected) (3). It is noted that when OFC transmits a packet through OFS, in a case where the OFC receives the received packet from the OFS with the Packet-In message, the OFC transmits a Packet-Out message to OFS.

The OFS 122, upon reception of the Packet-Out message from the OFC 110, broadcasts the received ARP request packet within the same logical network 141 (4). Herein, only the communication terminal 131-2 belongs to the same logical network 141. When the OFC 110 receives the Packet-In message from the OFS 121, the OFC 110 registers a correspondence between a MAC address of the communication terminal 131-1 and the number of the port of the OFS 121 connected to the MAC address in the table in FIG. 10B. With this arrangement, connection of the communication terminal 131-1 with the MAC address to the destination of the port 1 of the OFS 121 is stored in FIG. 10B.

When the communication terminal 131-2 receives the ARP request from the OFS 122, the communication terminal 131-2 recognizes that a MAC address of the communication terminal 131-2 is inquired because a destination IP address matches an IP address of the communication terminal 131-2. The communication terminal 131-2 transmits in unicast an ARP reply (packet) (including the MAC address of the communication terminal 131-2 corresponding to the destination IP address) to the OFS 122, as a response to the ARP request (5).

The OFS 122 receives the ARP reply packet from the communication terminal 131-2. A flow entry corresponding to the received ARP reply packet is not present in the OFS 122, and a flow of the ARP reply packet is a new flow. For this reason, the OFS 122 transmits a Packet-In message to the OFC 110 and requests the OFC 110 to perform path setting for the received ARP reply (6).

When the OFC 110 recognizes a destination MAC address of the ARP reply packet received from the OFS 122 using information in FIG. 10B, the OFC 110 rewrites information in the ARP reply packet, and transmits a Packet-Out message to the OFS 121 (8). The OFS 121 forwards the ARP reply packet to the communication terminal 131-1 (9).

### <Packet-Out and FlowMod Messages>

When a packet received by OFC with Packet-In message is transmitted to OFS using a Packet-Out message, it is also possible for the OFC not to set a flow entry for OFS. In that case, however, since a flow entry is not set, each time when the OFS receives the same packet, OFS transmits a Packet-In message to OFC. Then, OFC 110 may respectively set Flow Modify (Flow Modify, which is abbreviated as “FlowMod”) messages (7-1 to 7-3) to the OFSs for setting a path for an ARP reply so that the ARP reply to be subsequently transmitted does not pass through the OFC 110. When the OFC 110 receives the Packet-In message from the OFS 122, the OFC 110 registers in the table in FIG. 10B a correspondence between the MAC address of the communication terminal 131-2 set in a frame of the ARP reply and the number of the port of the OFS 122 connected to the MAC address.

When an MAC address of the communication terminal 131-2 is resolved, the communication terminal 131-1 transmits a data packet to the communication terminal 131-2.

When the OFS 121 receives the data packet, the OFS 121 transmits a Packet-In message to the OFC 110 because the flow of the data packet is a new flow. The OFS 121 thereby requests to the OFC 110 to perform path setting for the received data packet.

The OFC 110 recognizes location information (OFS 122, port number 1) of the destination MAC address (communication terminal 131-2) of the received data packet, using the information in FIG. 10B. The OFC 110 transmits a FlowMod message to each of the OFSs 121, 122, and 123 so that one or more packets to be subsequently transmitted does not pass through the OFC 110, thereby setting a flow entry defining a path for forwarding data packets in each of the OFSs 121, 122, and 123. Then, the OFC 110 transmits a Packet-Out message to the OFS 121 (13). The OFS 121, upon reception of the Packet-Out message, forwards a data packet to the OFS 122. The OFS 122 forwards the data packet to the communication terminal 131-2. Thereafter, data packet forwarding is performed between the communication terminal 131-1 and the communication terminal 131-2 through the OFSs 121 and 122. With the above processing, communication within a logical network is implemented.

### <Inter-Logical Networks Communication (Communication Between Different Subnets)>

FIG. 13 illustrates an example of path control processing when communication between different logical networks (communication between the communication terminal 131-1 of the logical network 141 and the communication terminal 132 of the logical network 142) is performed. As described before, when broadcasting or the like of an ARP request or the like is performed between the different logical networks, L3 routing becomes necessary.

Referring to FIG. 13, the communication terminal 131-1 transmits an ARP request for MAC address resolution of the default gateway in order to transmit a packet to the communication terminal 132 (1). The IP address of the default gateway that functions as a router between the different logical networks is set in the frame of the ARP request, as a destination IP address.

Upon reception of an ARP request (packet) by the OFS 121, since a flow of the ARP request is a new flow, the OFS 121 transmits a Packet-In message to the OFC 110 (2). The OFS 121 thereby requests to the OFC 110 to perform path setting for the received ARP request.

Since a destination IP address (destination IP address targeted for MAC address acquisition) set in the received packet (ARP request packet) is that of a default gateway, the OFC 110 generates an ARP reply (including an MAC address of the default gateway) that is a response for the ARP request and transmits a Packet-Out message to the OFS 121. The OFC 110 stores and manages information (information of MAC address and IP address) of the default gateway between the logical networks 141 and 142.

The OFS 121 transmits the ARP reply (that is the response for the ARP request and includes the MAC address of the default gateway) to the communication terminal 131-1. When the OFC 110 receives the Packet-In message, the OFC 110 registers location information of the communication terminal 131-1 (correspondence between a MAC address and a port number of the OFS 121) in the table in FIG. 10B.

The communication terminal 131-1 receives the ARP reply (including the MAC address of the default gateway). When a MAC address of the default gateway is resolved, the communication terminal 131-1 transmits to the communication terminal 132 a data packet (with the header destination address thereof set to the MAC address of the default gateway and with the IP address of the communication terminal 132 set to the destination IP address)(5).

Upon reception of the data packet transmitted by the communication terminal 131-1, since the flow of the data packet is a new flow, the OFS 121 transmits a Packet-In message to the OFC 110 (6). The OFS 121 thereby requests the OFC 110 to perform path setting for the received packet.

The OFC 110, when receiving the Packet-In message from the OFS 121, recognizes that the destination MAC address of a data packet header is a MAC address of the default gateway (OFC 110). The OFC 110 buffers the data packet received by the Packet-In message from the OFS 121 (7). Using a destination IP address of the data packet, the OFC 110 searches an ARP cache in FIG. 11B to try to resolve a MAC address associated with the destination IP address. When the MAC address is resolved by the OFC 110, the location information of the communication terminal 132 (the number of the port of the OFS 123 connected to the communication terminal 132) is further resolved, using the location information in FIG. 10B.

The OFC 110 calculates a path, and transmits a FlowMod message to each of the OFSs 121, 122, and 123 (13-1 to 13-3) to set a flow entry defining a path for forwarding the data packet. Further, the OFC 110 transmits a Packet-Out message to the OFS 121 (14).

The OFS 121 forwards the data packet to the OFS 122, and then forwards the data packet from the OFS 122 to the communication terminal 131-2 through the OFS 123 according to the flow set by the OFC 110. Thereafter, data packet forwarding is performed between the communication terminal 131-1 and the communication terminal 131-2 through the OFSs 121, 122, and 123.

The OFC 110, when receiving an Packet-In message from the OFS 121, searches the ARP cache in FIG. 11B to try to resolve a MAC address associated with a destination IP address of a data packet. When the MAC address associated with the destination IP address is not registered in the ARP cache and a MAC address cannot be therefore resolved by the OFC 110, the OFC 110 buffers the received packet (which is indicated by a broken line 7). Then, the OFC 110 identifies a logical network (logical network 142) associated with the destination IP address of the data packet (communication terminal 132: IP address: 192. 168. 2. 1), using the information in FIG. 11A. When the logical network can be identified, the OFC 110 generates an ARP request message for resolving the MAC address of the communication terminal having the destination IP address of the data packet. Then, the OFC 110 sets the generated ARP request in a Packet Out message and transmits the Packet-Out message to the OFS 123 connected to the logical network 142 associated with the destination IP address (8).

The OFS 123, upon reception of the Packet Out message (packet forwarding instruction) from the OFC 110, broadcasts the ARP request included in the Packet Out message within the logical network 142 (which is indicated by a broken line 9), in order to resolve a MAC address associated with the destination IP address.

Since the IP address of the broadcast ARP request is identical to the IP address of its own node, the communication terminal 132 connected to the logical network 142 determines that a MAC address of its own node is inquired, sets the MAC address of its node in the packet of an ARP reply, and then transmits in unicast the ARP reply to the OFS 123 (10). When receiving the ARP reply from the communication terminal 132 (which is indicated by a broken line 10), since a flow of the ARP reply is a new flow, the OFS 123 transmits a Packet-In message to the OFC 110 (which is indicated by a broken line 11).

The OFC 110, upon reception of the ARP reply by the Packet-In message from the OFS 123, can resolve a MAC address. Consequently, the OFC 110 can release buffering of the data packet buffered, when receiving the Packet-In message received from the OFS 121 (6) (which is indicated by a broken line 12). The OFC 110 executes processing which is the same as that when the MAC address could be resolved, as subsequent processing. That is, in order to set the path between the communication terminal 131-1 and the communication terminal 132, the OFC 110 transmits a FlowMod message to each of the OFSs 121, 122, and 123 (13-1 to 13-3) to set each flow entry defining a path for forwarding the data packet. Next, the OFC 110 transmits the Packet-Out message to the OFC 121 (14). The OFS 121, upon reception of the Packet-Out message, forwards the data packet to the OFS 122. The data packet is then forwarded from the OFS 122 to the OFS 123, and is then forwarded from the OFS 123 to the communication terminal 132. Thereafter, the data packet forwarding (including bidirectional forwarding) is performed between the communication terminal 131-1 of the logical network 141 and the communication terminal 132 of the logical network 142 through the OFS 121, the OFS 122, and the OFS 123. Communication between different logical networks is implemented by the above-mentioned processing.

### CITATION LIST

### Patent Literature

[PTL 1]
International Publication No. WO2008/095010

### Non Patent Literature

[NPL 1]
Nick McKeown and seven other authors, “OpenFlow: Enabling Innovation in Campus Networks,” [online], [Searched on October 31, Heisei 24], Internet <URL: http://www.openflowswitch.org//documents/openflow-wp-latest.pdf>.
[NPL 2]
“OpenFlow Switch Specification” Version 1.1.0 Implemented (Wire Protocol 0x02), [Searched on October 31, Heisei 24], Internet <URL: http://www.openflowswitch.org/documents/openflow-spec-v1.1.0.pdf>.

### SUMMARY

### Technical Problem

Analyses of the related arts will be given below. The following description will be given with reference to a system configuration (that is an example of a prototype) illustrated in FIG. 14. Referring to FIG. 14, this communication system (an example of a prototype) includes an OFC 110, OFSs 121 to 123, and communication terminals 131-1, 131-2, and 132. Numerals described beside lines between the communication terminals and the OFSs indicate numbers of ports of the OFSs to which the communication terminals are connected. FIG. 14 is different from FIG. 9 described before in terms of subnets assigned to each logical network. In the example in FIG. 9, one global subnet is assigned to one logical network. As illustrated in FIG. 11A, subnets of logical networks 141 and 142 are respectively given by “192. 168. 1. 0/24” and “192. 168. 2. 0/24”.

Referring to FIG. 14, two subnets are assigned to one logical network. Though one of the two subnets is assigned for each of the logical networks 141 and 142, this subnet is a private subnet (192. 168. 1. 0/24) that duplicates between the logical networks 141 and 142. The other one of the two subnets is a global subnet (172. 17. 0. 0/24) assigned across a plurality of the logical networks. The term global/private has been used for explaining the subnet. The global subnet means a subnet capable of being uniquely identified on the communication system. The private subnet means a subnet such as 192. 168. 1. 0/24 in FIG. 14 assigned to duplicate between the logical networks 141 and 142 and cannot be uniquely identified on the communication system.

Communication within a global subnet (172. 17. 0. 0/24) and communication within a private subnet cannot be simultaneously implemented in the system in FIG. 14. It is because an L2 broadcast domain cannot appropriately be selected.

To take an example, as described in FIG. 12, since

L2 broadcast domain=logical network,

communication within a private subnet can be implemented. However, communication between the communication terminals 131-1 and 132 using the global subnet cannot be implemented, because MAC address resolution using ARP cannot be performed.

Assuming, as another example, that the following holds:

L2 broadcast domain=communication system,

the communication (communication between the communication terminals 131-1 and 132) within the global subnet can be implemented. However, the communication within the private subnet (communication between the communication terminals 131-1 and 131-2) cannot be implemented, because address spaces of the logical networks 141 and 142 collide (the communication terminals 131-1 and 132 have the IP address of 192. 168. 1. 1).

As mentioned above, when a network architecture configured to control communication by defining a plurality of logical networks on one physical network in the network architecture of a centralized control type such as OpenFlow, there may result restriction or the like on a logical network communication enabled range according to network address assignment to disable implementation of a flexible relationship between logical network and subnet.

The present invention has been devised in terms of the above-mentioned problem. An object of the present invention is to provide a communication system, a control apparatus, a communication apparatus, a communication method, and a program capable of removing restriction or the like to a logical network communication enabled range resulted according to assignment of a predetermined network address, thereby increasing communication flexibility.

### Solution to Problem

According to one of some related aspects (aspect 1) of the disclosed invention, there is provided a communication system comprising:

a control apparatus configured to generate a processing rule that defines packet processing in a communication apparatus and set the generated processing rule in the communication apparatus; and

the communication apparatus configured to process a received packet according to the processing rule set by the control apparatus, wherein

the control apparatus includes:

a first storage and management unit configured to store and manage information of a logical network to which the communication apparatus is connected;

a second storage and management unit configured to store and manage a correspondence relationship between a network address and the logical network; and

a determination unit configured to determine one or more logical networks for broadcast targets, based on the correspondence relationship between the network address and the logical network; and

wherein the determination unit of the control apparatus identifies one or more communication apparatuses connected to the determined one or more logical networks by referring to the first storage and management unit with respect to the determined one or more logical networks and sets the one or more communication apparatuses to perform broadcast transmission to the determined one or more logical networks.

According to another one of the aspects (aspect 2), there is provided a control apparatus configured to generate a processing rule that defines packet processing in a communication apparatus and set the generated processing rule in the communication apparatus, wherein the control apparatus comprises:

a first unit configured to store and manage information of a logical network to which the communication apparatus is connected;

a second unit configured to store and manage a correspondence relationship between a network address and the logical network; and

a third unit configured to determine one or more logical broadcast transmission target networks, based on the correspondence relationship between the network address and the logical network; and

wherein the third unit executes control to identify one or more communication apparatuses connected to the determined one or more logical networks by referring to the first unit with respect to the determined one or more logical networks and cause the one or more communication apparatuses to perform broadcast transmission to the determined one or more logical networks.

According to further another one of the aspects (aspect 3), a method by a control apparatus configured to generate a processing rule that defines packet processing in a communication apparatus and set the generated processing rule in the communication apparatus includes the followings:

in a storage unit of the control apparatus, storing and managing information of a logical network to which the communication apparatus is connected;

in a storage unit of the control apparatus, storing and managing a correspondence relationship between a network address and the logical network;
determining one or more logical networks for broadcast targets, based on the correspondence relationship between the network address and the logical network; and

identifying one or more communication apparatuses connected to the determined one or more logical networks by referring to the first storage unit with respect to the determined one or more logical networks and setting the one or more communication apparatuses to perform broadcast transmission to the determined one or more logical networks.

According to yet another one of the aspects (aspect 4), there is provided a program for a computer constituting a control apparatus configured to generate a processing rule that defines packet processing in a communication apparatus and set the generated processing rule in the communication apparatus, the program causing the computer to execute:

first processing of storing and managing in a storage unit information of a logical network to which the communication apparatus is connected;

second processing of storing and managing in a storage unit a correspondence relationship between a network address and the logical network;

third processing of determining one or more logical networks for broadcast targets, based on the correspondence relationship between the network address and the logical network; and

fourth processing of identifying one or more communication apparatuses connected to the determined one or more logical networks by referring to the first storage unit with respect to the determined one or more logical networks and setting the one or more communication apparatuses to perform broadcast transmission to the determined one or more logical networks.

According to still another one of the aspects (aspect 5), there is provided a computer readable non-transitory medium (computer readable non-transitory medium) (such as a semiconductor memory or a magnetic/optical disk) storing the program.

### Advantageous Effects of Invention

According to the present invention, restriction to a logical network communion enabled range that may occur according to assignment of a predetermined network address is removed. Communication flexibility can be thereby increased.

### BRIEF DESCRIPTION OF DRAWINGS

FIG. 1 is a diagram illustrating a configuration example of a communication system according to a first exemplary embodiment.

FIG. 2 is a diagram illustrating a configuration example of a path control function 10 according to the first exemplary embodiment.

FIG. 3 comprises FIGS. 3A and 3B, wherein FIG. 3A is a logical network management information table, and FIG. 3B is a location management information table.

FIG. 4 comprises FIGS. 4A and 4B, wherein FIG. 4A is a routing management information table, and FIG. 4B is an ARP cache management information table.

FIG. 5 is a diagram (diagram 1) illustrating a sequence operation of path control according to the first exemplary embodiment.

FIG. 6 is a diagram (diagram 2) illustrating a sequence operation of path control according to the first exemplary embodiment.

FIG. 7 is a flowchart for explaining a broadcasting target logical network determination procedure, according to the first exemplary embodiment.

FIG. 8 is a diagram illustrating information (flow entry) held in a flow table provided in an OpenFlow switch.

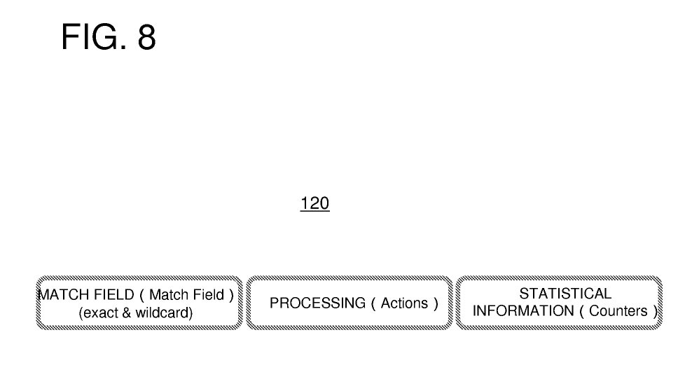

FIG. 9 is a diagram illustrating a configuration example of a communication system.

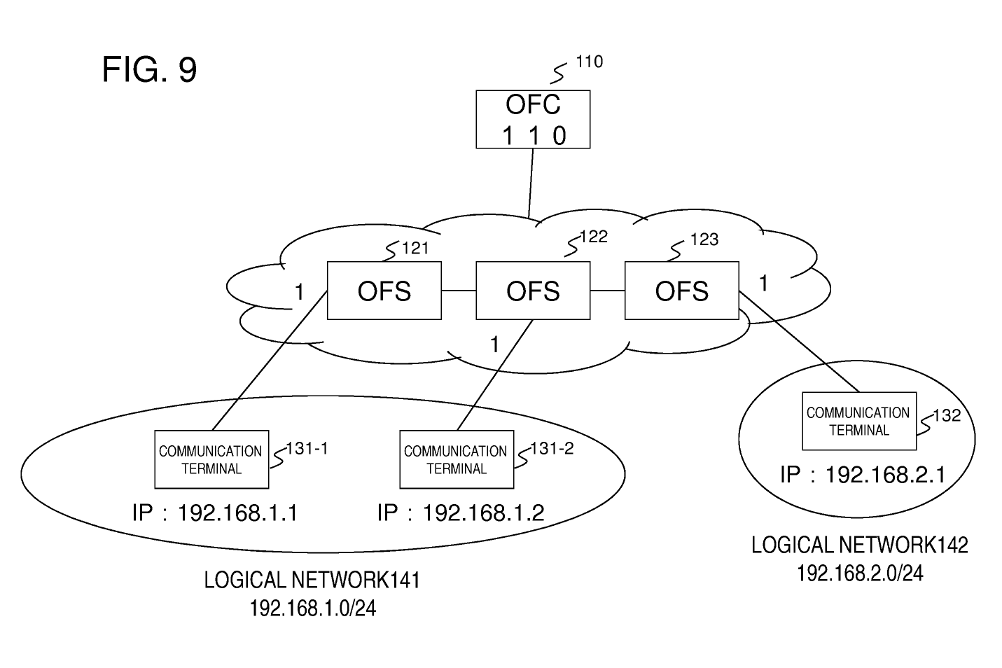

FIG. 10 comprises FIGS. 10A and 10B, wherein FIG. 10A is a table explaining a logical network management information table, and FIG. 10B is a table explaining a location management information table.

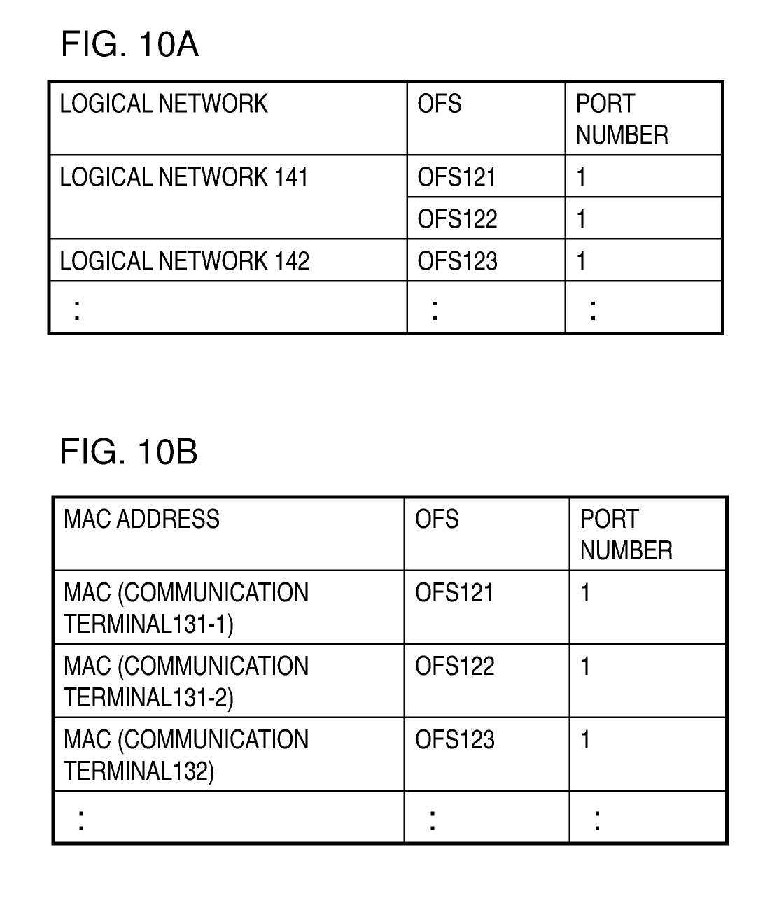

FIG. 11 comprises FIGS. 11A and 11B, wherein FIG. 11A is a table explaining a routing management information table, and FIG. 11B is a table explaining an ARP cache management information table (ARP table).

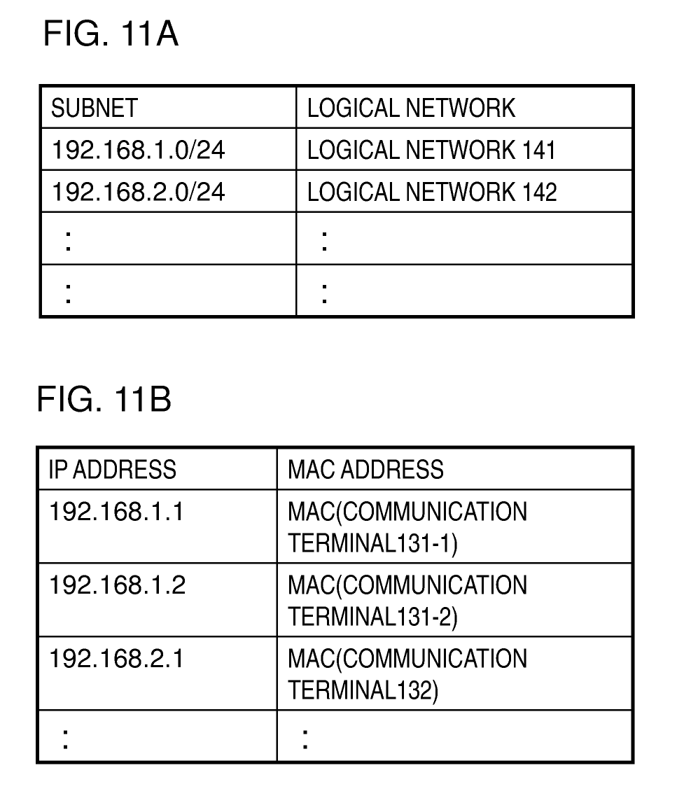

FIG. 12 is a diagram illustrating an operation example of path control when communication within a logical network is performed.

FIG. 13 is a diagram illustrating an operation example of path control when communication between logical networks is performed.

FIG. 14 is a diagram explaining a configuration example of a communication system.

FIG. 15 is a diagram illustrating a basic configuration of an exemplary embodiment of the present invention.

FIG. 16 is a diagram explaining an ARP frame format.

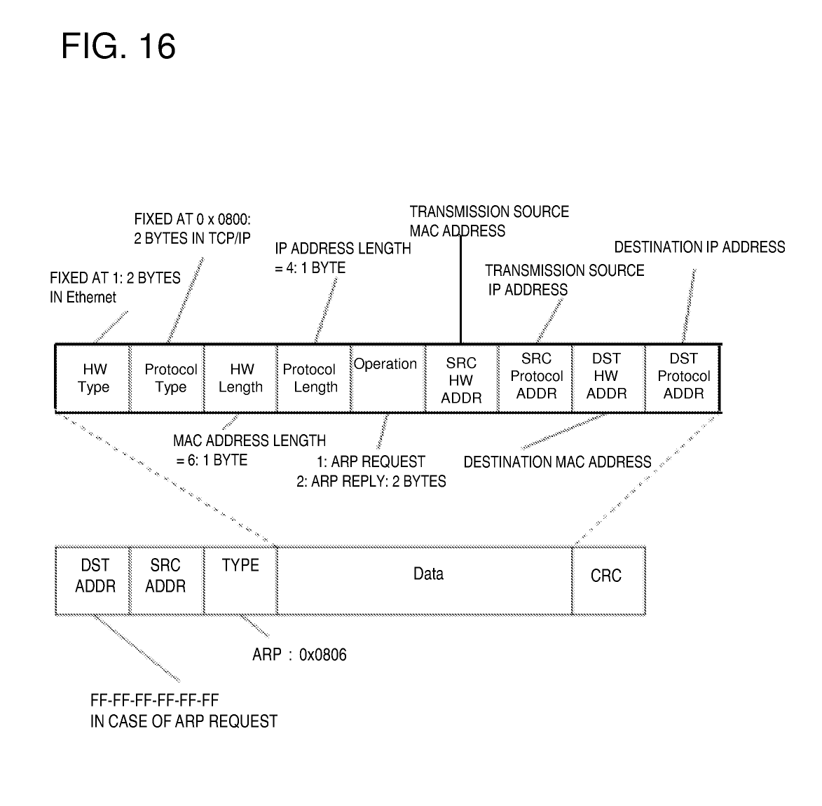

FIG. 17 is a table for explaining a subnet associated with a router.

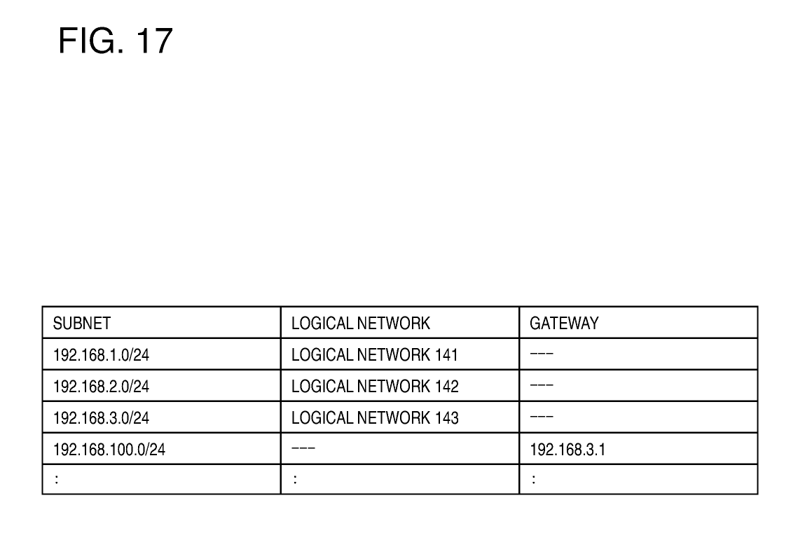

### DESCRIPTION OF EMBODIMENTS

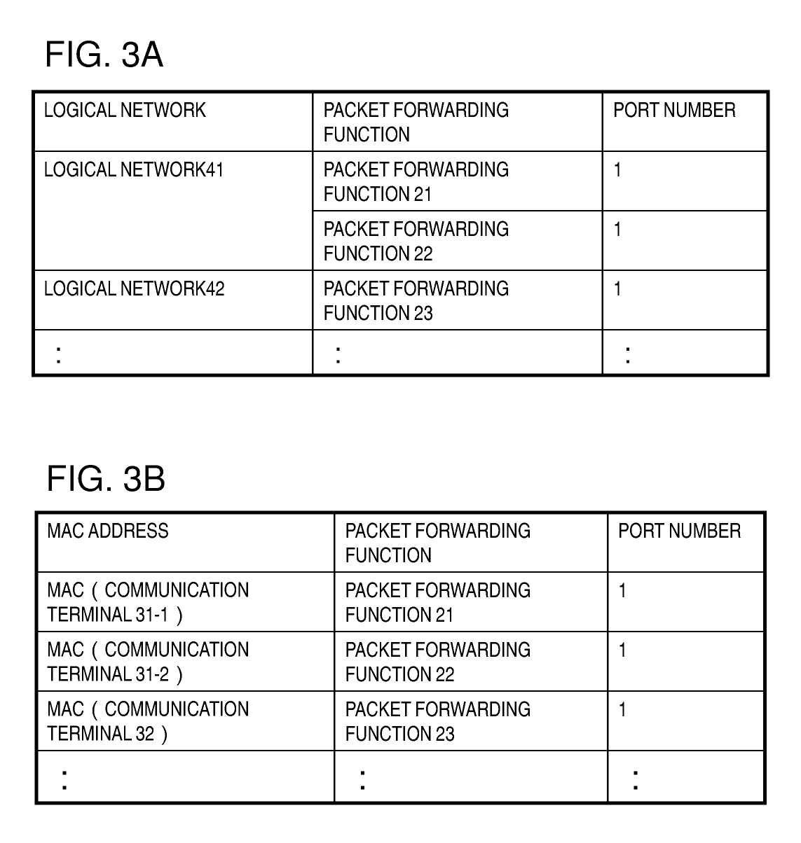

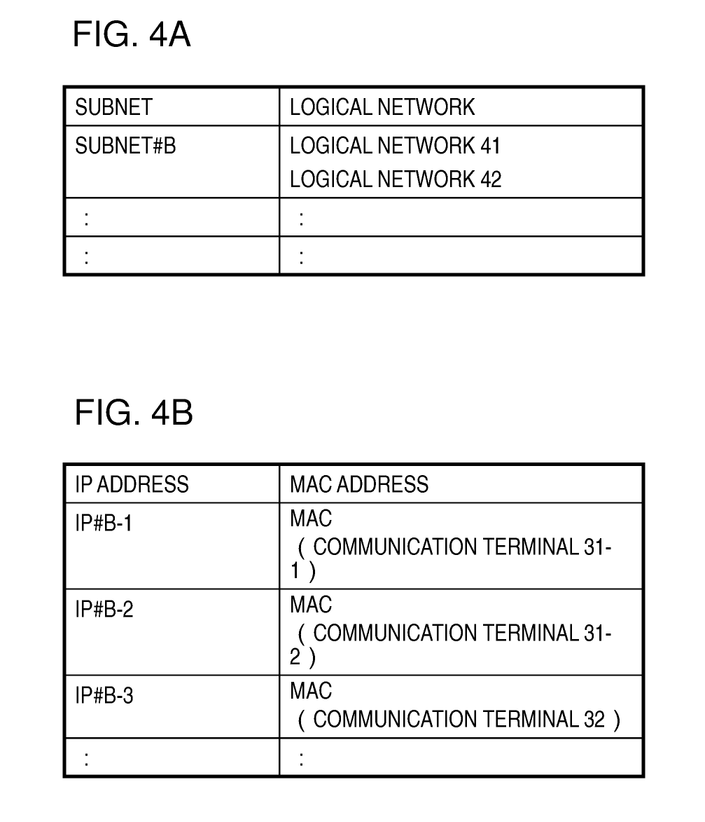

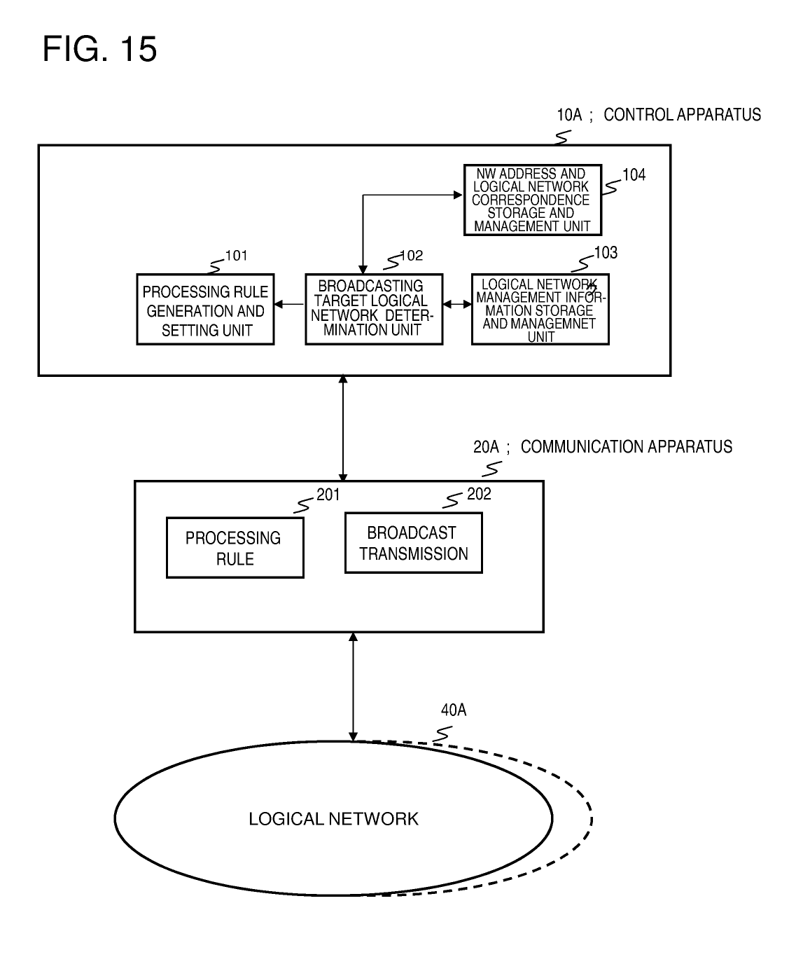

Some exemplary embodiments of the present invention will be described. Referring to FIG. 15, in one aspect of some preferred modes and exemplary embodiments of the present invention, for a communication apparatus (20A) configured to process a received packet according to a processing rule (201), a processing rule generation and setting unit (101) of a control apparatus (10A) generates a processing rule and sets the generated processing rule in the communication apparatus (20A). The control apparatus (10A) includes a first storage and management unit (logical network management information storage and management unit 103) configured to store and manage information (logical network management information in FIG. 3A) of a logical network (40A) to which the communication apparatus (20A) is connected, a second storage and management unit (network address and logical network correspondence storage and management unit 104) configured to store and manage a correspondence between a network address (such as a subnet) and the logical network to which the network address is assigned (routing management information in FIG. 4A), and a determination unit (broadcasting target logical network determination unit 102) configured to determine to which logical network (broadcast transmission target logical network) broadcast transmission is to be performed, based on a corresponding relationship between a network address (such as subnet) and a logical network. In the communication apparatus (20A) connected to a logical network determined by the control apparatus, a broadcast transmission unit (202) performs broadcast transmission to the determined logical network. In the communication apparatus (20A) connected to the logical network determined by the control apparatus, the broadcast transmission unit (202) performs broadcast transmission to the determined logical network (40A). That is, the determination unit (broadcasting target logical network determination unit 102) of the control apparatus (10A) performs control to identify one or more communication apparatuses connected to the determined one or more logical networks by referring to the first storage and management unit (logical network management information storage and management unit 103) with respect to the determined one or more logical networks and cause the one or more communication apparatuses to perform broadcast transmission to the determined one or more logical networks (40A).

The determination unit (broadcasting target logical network determination unit 102) of the control apparatus (10A) receives a network address (such as a subnet). When an entry that defines a correspondence between the network address and one or more logical networks is present in the second storage and management unit (network address and logical network correspondence storage and management unit 104), the determination unit determines the one or more logical networks (40A) associated with the network address, as one or more logical networks for broadcasting targets.

The determination unit (broadcasting target logical network determination unit 102) of the control apparatus (10A) receives the network address (such as a subnet). When the entry that defines the correspondence between a network address and a logical network is not present in the second storage and management unit (network address and logical network correspondence storage and management unit 104), the determination unit determines a logical network to which the transmission source of a broadcasting request (such as an ARP request) belongs, as a broadcasting target logical network.

As illustrated in FIG. 4A, for example, the second storage and management unit (network address and logical network correspondence storage and management unit 104) includes a correspondence between a network address (such as a subnet #B) assigned to a plurality of the different logical networks (such as logical networks 41 and 42) in common and the plurality of the different logical networks (41, 42) having the network address (subnet #B) in common, as an entry. A network address (#A) different from the network address (subnet #B) may be assigned to the plurality of the different logical networks.

When information of a predetermined address included in the broadcasting request (such as the ARP request) is different from that of a node (such as a default gateway) between a logical network to which a broadcasting request source belongs and another logical network, the determination unit (broadcasting target logical network determination unit 102) of the control apparatus (10A) may determine the broadcasting target logical network. According to a preferred mode of the present invention, restriction to a logical network communion enabled range or the like resulted according to assignment of a predetermined network address is removed, and communication flexibility is thereby increased.

A description will further be given below in conjunction with an exemplary embodiment. A reference sign in the drawing appended to this overview is given solely for helping understanding, and does not intend to limit the present invention to the mode that has been illustrated. In the following description, a packet means a unit for data forwarding.

### First Exemplary Embodiment

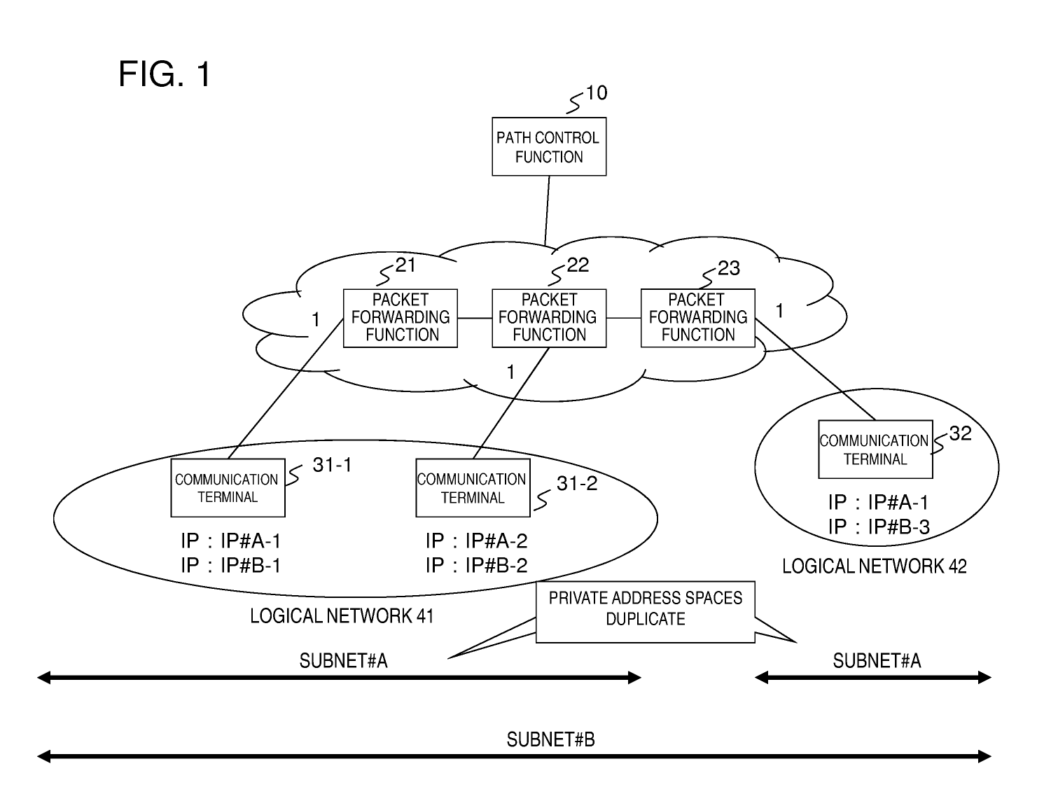

Referring to FIG. 1, a communication system in an exemplary embodiment of the present invention includes a plurality of packet forwarding functions 21, 22, and 23 and a path control function 10. Each of packet forwarding functions 21, 22, and 23 is configured to process a received packet according to a packet forwarding rule (processing rule) that associates a matching rule for identifying a flow and processing content to be applied to the matching rule. The path control function 10 is configured to set the packet forwarding rule in each of the packet forwarding functions 21, 22, and 23. Communication terminals 31-1, 31-2, and 32 are connected to this communication system. The communication terminal 31-1 and the communication terminal 31-2 belong to a logical network 41. The communication terminal 32 belongs to a logical network 42. Each of the packet forwarding functions 21, 22, and 23 may be implemented in a node apparatus connected to a network. The path control function 10 may be implemented in a control apparatus configured to control the node apparatus (communication apparatus).

### <Subnet Assignment Example (Global/Private)>

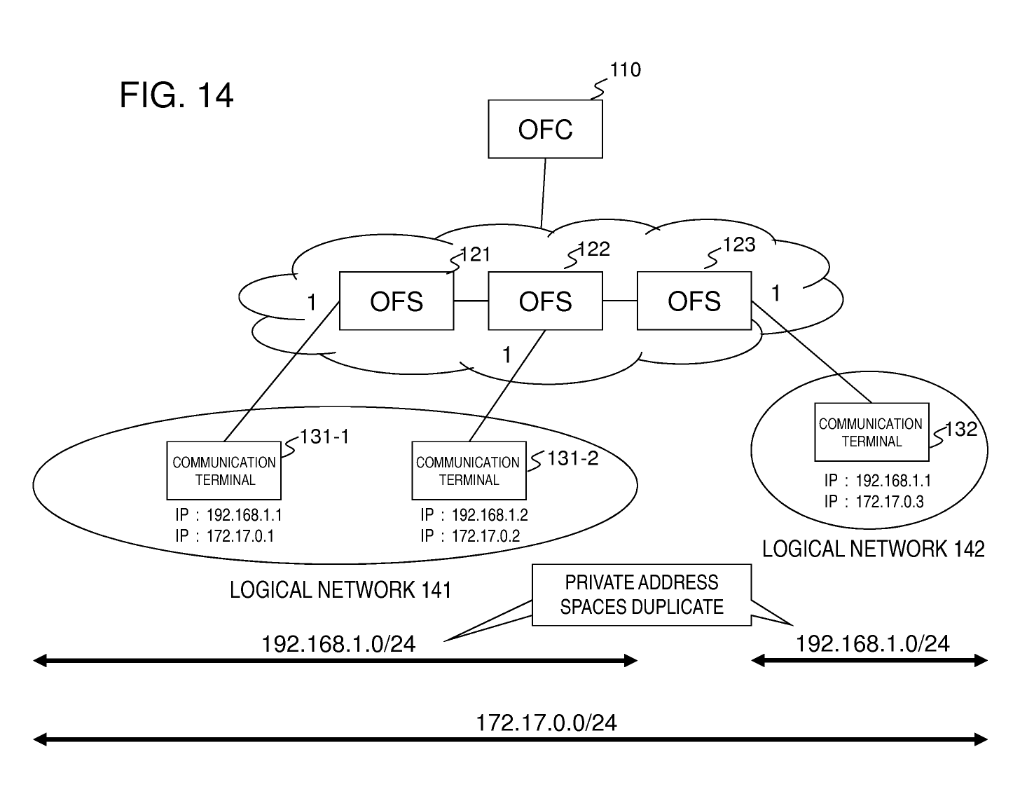

Two types of subnets are assigned to each of the logical network 41 and the logical network 42. One of the two types of subnets is a subnet #A, which is a private subnet that duplicates between the logical network 41 and the logical network 42. The other one of the two types of subnets is a subnet #B, which is a global subnet assigned across the logical network 41 and the logical network 42. Numerals described beside lines between the communication terminals and the packet forwarding functions indicate numbers of ports of the packet forwarding functions to which the communication terminals are connected. Though no particular limitation is imposed, assume that the IPv4 (Internet Protocol Version 4) IP address of the subnet #A is set to “192. 168. 1. 9/24”, the IPv4 IP address of the subnet #B is set to “172. 17. 0. 0/24”, and the path control function 10 and the packet forwarding functions 21, 22, and 23 are respectively associated with an OFC 110, an OFS 121, an OFS 122, and an OFS 123. Then, this communication system can be associated with an OpenFlow system in FIG. 14. That is, as is clear from the following description, the problem of the system in FIG. 14 described before can be solved by applying the present exemplary embodiment to the system in FIG. 14.

### <Configuration Example of Path Control Function>

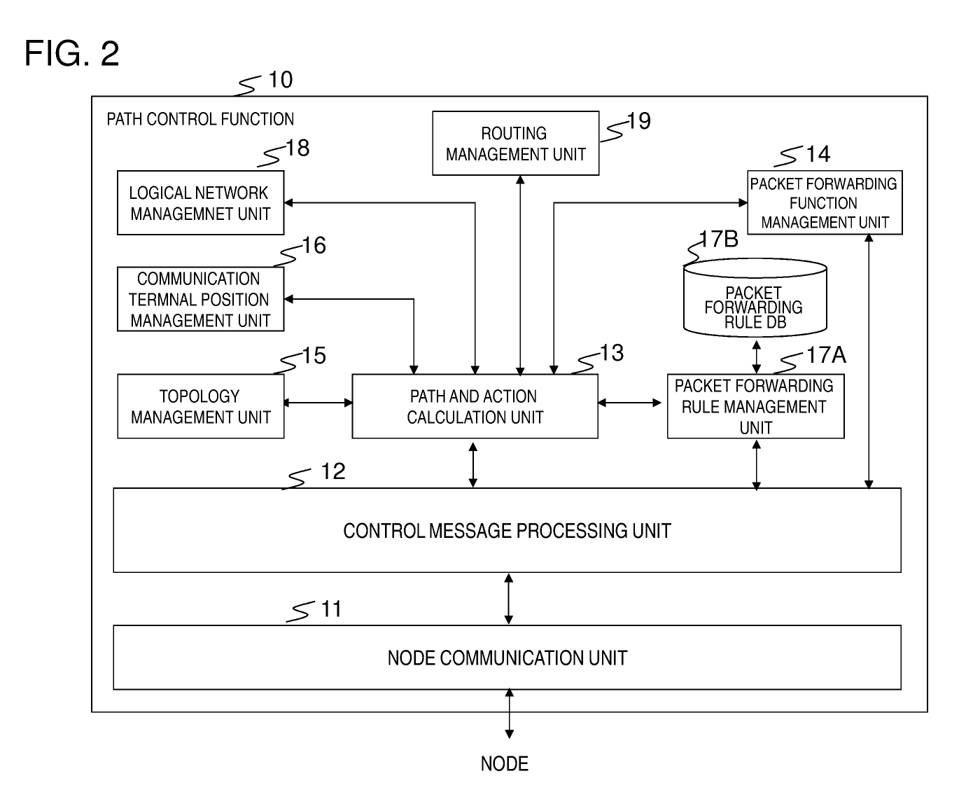

FIG. 2 is a diagram illustrating a configuration of the path control function 10 in FIG. 1. Referring to FIG. 2, the path control function 10 is configured by including a node communication unit 11 configured to perform communication with each of the packet forwarding functions 21 to 23, a control message processing unit 12, a path and action calculation unit 13, a packet forwarding function management unit 14, a topology management unit 15, a communication terminal location management unit 16, a packet forwarding rule management unit 17A, a logical network management unit 18, and a routing management unit 19. Each of the units operates as follows.

The control message processing unit 12 analyzes a control message received from each of the packet forwarding functions 21 to to deliver information on the control message to relevant processing means within the path control function 10.

The path and action calculation unit 13 determines an action to be executed by each packet forwarding function on a packet forwarding path, based on the following information:

location information of the communication terminal managed by the communication terminal location management unit 16;

topology information constructed by the topology management unit 15;

logical network information managed by the logical network management unit 18; and

routing information managed by the routing management unit 19.

The path and action calculation unit 13 identifies the logical network targeted for broadcasting (that is a broadcasting target) of a packet for which the broadcasting is necessary, and executes the broadcasting based on the following information:

the logical network information managed by the logical network management unit 18; and

the routing information managed by the routing management unit 19.

The packet forwarding function management unit 14 manages ability of each packet forwarding function (such as the number and types of ports and the types of actions to be supported) controlled by the path control function 10.

The topology management unit 15 constructs the network topology information, based on a connection relationship of the packet forwarding functions, collected via the node communication unit 11.

### <Communication Terminal Location Management Unit and Location Management Information Table>

The communication terminal location management unit 16 manages the information for identifying the position of each communication terminal connected to the communication system. The communication terminal location management unit 16 manages a location management information table as illustrated in FIG. 3B, for example. The example in FIG. 3B stores each MAC address and the packet forwarding function connected to the communication terminal (node) with the MAC address and the number of the port of the packet forwarding function connected to the communication terminal (node) with the MAC address, in association with one another. The communication terminal location management unit 16 includes a storage unit configured to store the location management information table in FIG. 3B (the storage unit, however, may be configured to be provided outside of the communication terminal location management unit 16).

As illustrated in FIG. 3B, the location management information table in this exemplary embodiment uses:

MAC address, as information for identifying the point of connection of the communication terminal to the communication system; and

information for identifying the packet forwarding function to which the communication terminal is connected and information of the port of the packet forwarding function, as information for identifying the position of the communication terminal. It is noted that information used for the location management information table is not limited to such information, and different information may be employed.

The packet forwarding rule management unit 17A performs management regarding what type of packet forwarding rule is set in which packet forwarding function. More specifically, the packet forwarding rule management unit 17A registers a result of calculation by the path and action calculation unit 13 in a packet forwarding rule database (DB) 17B, as the packet forwarding rule.

The packet forwarding rule management unit 17A sets the packet forwarding rule in each of the packet forwarding functions. Further, when a change has occurred in the packet forwarding rule set in each of the packet forwarding functions by notification of deletion of the packet forwarding rule from one of the packet forwarding functions or the like, the packet forwarding rule management unit 17A updates the information registered in the packet forwarding rule database (DB) 17B so as to cope with the change.

### <Logical Network Management Unit and Logical Network Management Information Table>

The logical network management unit 18 manages each logical network constructed on the communication system. FIG. 3A is a table illustrating an example of a logical network management information table managed by the logical network management unit 18. As illustrated in FIG. 3A, the logical network management unit 18 manages each logical network by a port group of the packet forwarding functions. The logical network management unit 18 includes a storage unit not illustrated configured to store the logical network management information table in FIG. 3A (It is noted that the storage unit may be configured to be provided outside the logical network management unit 18). The logical network 41 in FIG. 1 is defined by a group of port number 1 of the packet forwarding function 21 and port number 1 of the packet forwarding function 22, and the logical network 42 in FIG. 1 is defined by a group of port number 1 of the packet forwarding function 23. It is noted that the present exemplary embodiment is not limited to an arrangement in which the logical network is managed with a port group and logical network may be managed with VLAN information or the like other than the port group, for example.

### <Routing Management Information Table>

The routing management unit 19 manages information for determining the destination of a packet flowing on the communication system. This information is constituted from routing information and ARP cache information, for example. The routing information in this exemplary embodiment is constituted from a correspondence relationship between each subnet and one or more of the logical networks associated with the subnet. The routing management unit 19 manages a routing management information table illustrated in FIG. 4A, for example. The routing management unit 19 includes a storage unit not illustrated to store the routing management information table illustrated in FIG. 4A (however, the storage unit may be configured to be provided outside the routing management unit 19). The example in FIG. 4A indicates that the subnet #B in FIG. 1 comprises the logical network 41 and the logical network 42. Though all subnets of the communication system in FIG. 1, for example, are associated with the logical networks as the routing information, a subnet associated with a router (not illustrated) may be provided.

### <ARP Cache>

FIG. 4B is a table illustrating the ARP cache information. The ARP cache information constitutes a table (ARP table) configured to manage the IP address and the MAC address of each communication terminal.

Though no entry related to the private subnet (subnet #A in FIG. 1) is present in the tables illustrated in FIGS. 4A and 4B, an entry related to the private subnet may be made to be present. In that case, however, additional information such as the logical network information or information indicating that a relevant one of the subnets is private or global becomes necessary.

When there is no need for the path control function 10 to hold a packet forwarding rule, the packet forwarding rule DB 17B can be omitted. The packet forwarding rule DB 17B may be configured to be separately provided at an external server or the like.

The path control function 10 may also be implemented by a configuration in which the logical network management unit 18 and the routing management unit 19 are added to an OFC disclosed in Non Patent Literature 1.

Each of the packet forwarding functions 21, 22, and 23, when receiving a packet, searches a packet forwarding rule table that stores packet forwarding rules, for a packet forwarding rule having a matching key that matches the received packet, and executes processing according to the action associated with the packet forwarding rule (e.g., forwarding of a packet to a specific port, flooding of a packet, discarding of a packet, MAC conversion, or the like). The packet forwarding functions 21, 22, and 23 may be of course implemented in first to third OFSs, respectively.

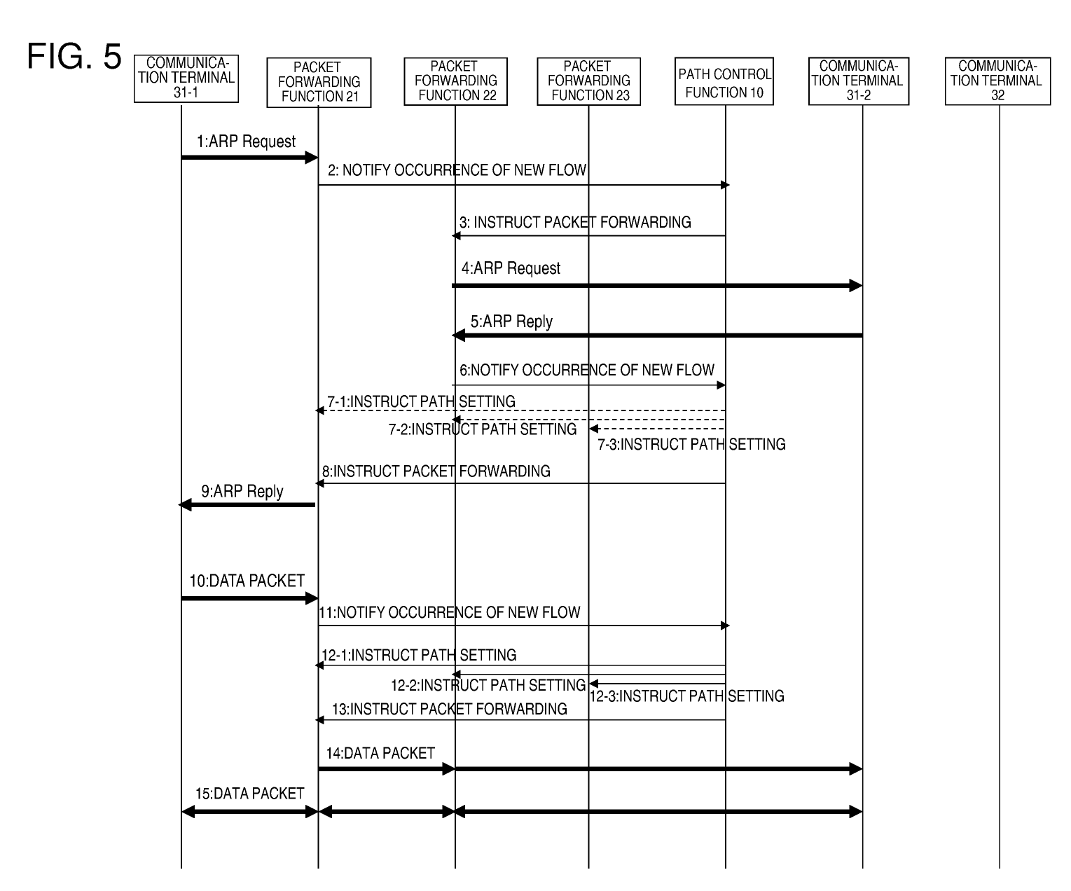

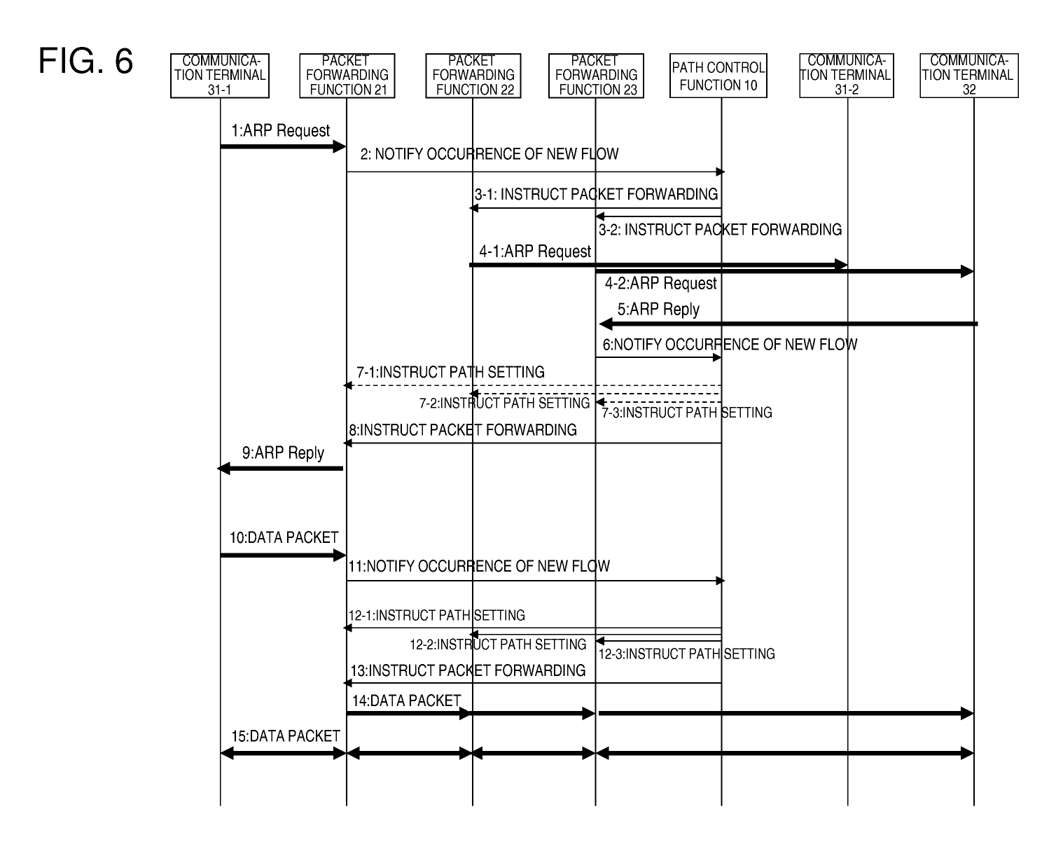

Next, the overall operation of this exemplary embodiment will be described in detail, with reference to FIGS. 5 and 6.

<Communication within Private Subnet>

FIG. 5 illustrates an example of path control sequences when communication within the private subnet (subnet #A in FIG. 1) associated with the single logical network (communication between the communication terminal 31-1 and the communication terminal 31-2) is performed. In the following description, a number in brackets appended to the end of a sentence that explains processing corresponds to the number of a representative sequence schematically illustrated in FIG. 5.

Referring to FIG. 5, the communication terminal 31-1 transmits an ARP request (packet) for MAC address resolution of the communication terminal 31-2 in order to transmit a packet to the communication terminal 31-2 belonging to the same logical network 41 (subnet #A) (1).

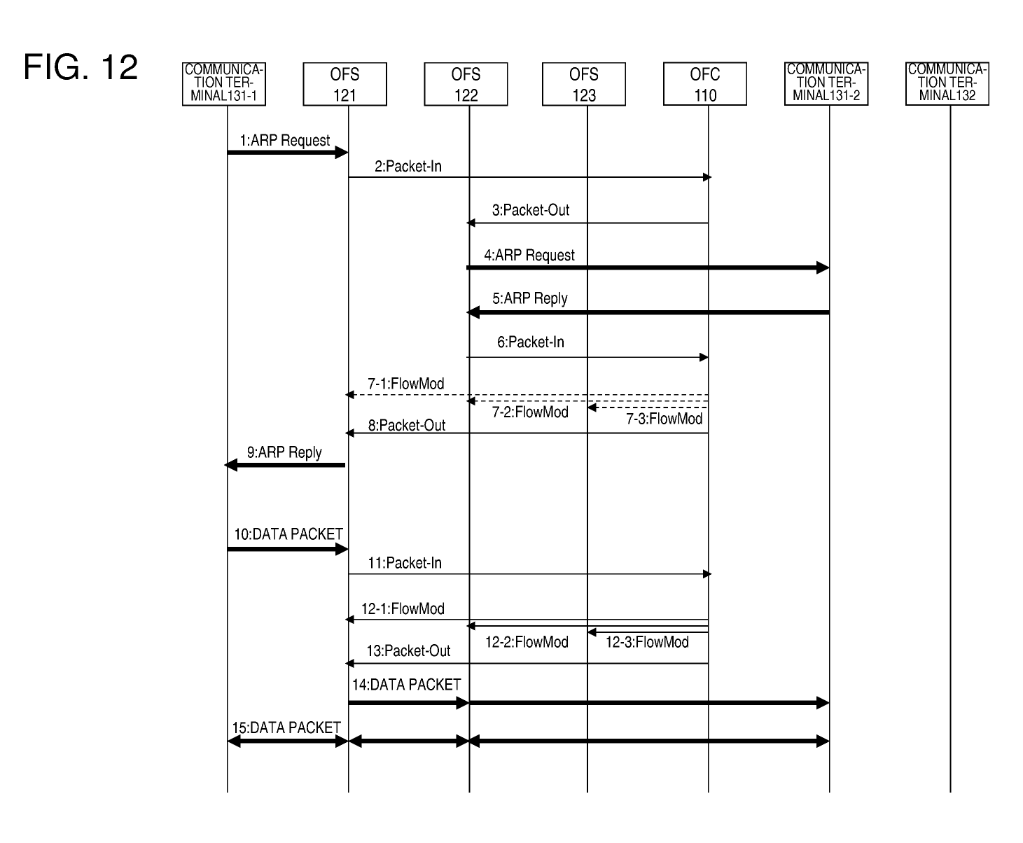

The packet forwarding function 21 receives the ARP request packet transmitted from the communication terminal 31-1. A forwarding path for the ARP request packet is not set in any packet forwarding rule in the packet forwarding function 21, and the flow of the ARP request packet is a new flow. Thus, the packet forwarding function 21 transmits a new flow occurrence notification message to the path control function 10 (2), to request the path control function 10 to perform path setting. The “new flow occurrence notification message” in FIG. 5 can also be associated with a “Packet-In message” illustrated in FIG. 12 or the like.

The path control function 10 confirms that the ARP request (packet) is an ARP request for MAC address resolution within the same subnet, based on the followings:

a destination MAC address of a header (Ethernet (registered trademark) header) of the packet in the new flow occurrence notification message from the packet forwarding function 21 is a broadcast address (of 48 bits that are all 1s), the packet including in a data portion thereof an ARP request frame; and

a destination IP address (destination IP address for MAC address resolution) within the ARP request frame is not the IP address of a default gateway.

Then, the path control function 10 determines a logical network to which the ARP request is to be broadcast.

### <Broadcasting Target Logical Network Determination Processing>

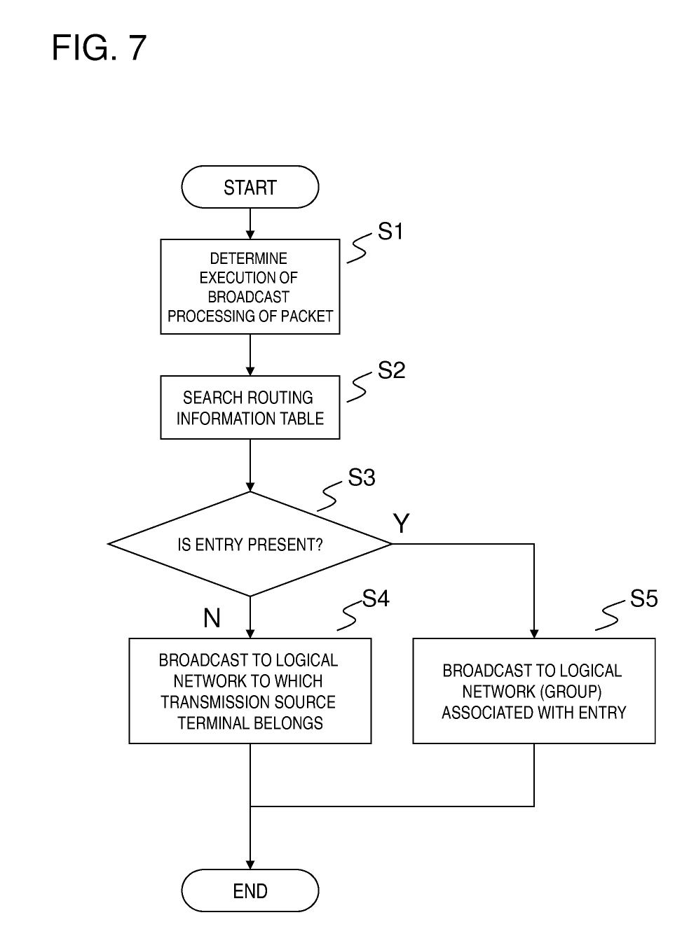

Referring to FIG. 7, a description will be directed to a procedure executed by the path control function 10 for determination processing of the logical network(s) to which broadcasting is to be performed. When the path control function 10 determines that execution of broadcast processing is necessary for a packet from the packet forwarding function (S1), the path control function 10 searches whether or not the (broadcasting target) subnet targeted for the broadcasting is registered in the routing management information table in FIG. 4A (S2). Herein, the subnet targeted for the broadcasting this time is the private subnet (subnet #A in FIG. 1). For this reason, a corresponding entry (entry of the logical network associated with the subnet #A) is not present in the routing management information table in FIG. 4A (No branch of S3). Thus, the path control function 10 determines the logical network to which the ARP request packet is to be broadcast is the logical network to which the communication terminal of a transmission source belongs (S4).

Referring again to FIG. 5, when the path control function 10 determines the logical network to which the broadcasting is to be performed (determines the logical network 41 that is the same as the logical network to which the communication terminal 31-1 of the transmission source belongs, in this case), the path control function 10 refers to the logical network management information table in FIG. 3A, determines to broadcast the ARP request from the port with port number 1 of the packet forwarding function 22 connected to the logical network 41, and then transmits a packet forwarding instruction message to the packet forwarding function 22 (3). The packet forwarding instruction message can also be associated with a Packet-Out message illustrated in FIG. 12 or the like.

When the packet forwarding function 22 receives the packet forwarding instruction message from the path control function 10, the packet forwarding function 22 broadcasts the ARP request within the logical network 41 (4). In this case, the packet forwarding function 22 transmits the ARP request to the communication terminal 31-2. The path control function 10 registers the location information of the communication terminal 31-1 (packet forwarding function 22 connected to the communication terminal 31-1 and its port number 1) in the location information management table in FIG. 3B when receiving the new flow occurrence notification message.

When the communication terminal 31-2 receives the ARP request from the packet forwarding function 22, the communication terminal 31-2 transmits in unicast an ARP reply with the MAC address of the communication terminal 31-2 set therein to the packet forwarding function 22, as a reply to the ARP request (5).

When the packet forwarding function 22 receives the ARP reply from the communication terminal 31-2, the packet forwarding function 22 transmits a new flow occurrence notification message to the path control function 10 because the flow of the ARP reply is a new flow (6). The packet forwarding function 22 thereby requests path setting for the received data packet.

When the path control function 10 recognizes the location information on the MAC address (packet forwarding function connected to the MAC address that has been resolved and the number of the port of the packet forwarding function connected to the MAC address) resolved by the received ARP reply, using the information in the location management table in FIG. 3B, the path control function 10 transmits the information on the ARP reply to the packet forwarding function 21 through a packet forwarding instruction message. The packet forwarding function 21 forwards the ARP reply to the communication terminal 31-1 (9).

Herein, the path control function 10 may set a path for forwarding the ARP reply so that the ARP reply to be subsequently transmitted does not pass through the path control function 10. That is, the path control function 10 transmits a path setting instruction message to each of the path forwarding functions 21, 22, and 23 (7-1, 7-2, and 7-3), thereby setting a packet forwarding rule in each of the packet forwarding functions 21, 22, and 23.

Upon reception of the new flow occurrence notification message from the packet forwarding function 22 (6), the path control function 10 registers the location information of the communication terminal 31-2 (packet forwarding function connected to the communication terminal 31-2 and port number 1 of the port of the packet forwarding function connected to the communication terminal 31-2) as well in the location information management table in FIG. 3B in a similar manner.

When a MAC address of the communication terminal 31-2 is resolved with reception of the ARP reply from the packet forwarding function 21, the communication terminal 31-1 transmits a data packet to the communication terminal 31-2 (10).

When the packet forwarding function 21 receives the data packet from the communication terminal 31-1, the packet forwarding function transmits a new flow occurrence message to the path control function 10 because the flow of the data packet is a new flow (11). The packet forwarding function 21 thereby requests the path control function 10 to perform path setting for the received data packet.

The path control function 10 recognizes the location information on the destination MAC address of the received data packet, using the information in the location information management table in FIG. 3B. The path control function 10 transmits a packet forwarding instruction message to the packet forwarding function 21 (13).

The path control function 10 transmits a path setting instruction to each of the packet forwarding functions 21, 22, and 23 (12-1, 12-2, and 12-3) so that the packet to be subsequently transmitted does not pass through the path control function 10, thereby setting a packet forwarding rule in each of the packet forwarding functions 21, 22, and 23.

The packet forwarding function 21 forwards the data packet received from the communication terminal 31-1 in the previous sequence 10 to the communication terminal 31-2 through the packet forwarding function 22 (14).

With the above-mentioned processing, the communication within the private subnet associated with the single logical network is implemented.

<Communication within Global Subnet>

FIG. 6 illustrates path control processing when communication (communication between the communication terminal 31-1 of the logical network 41 and the communication terminal 32 of the logical network 42) within the global subnet associated with a plurality of the different logical networks is performed. In the following description, a number in brackets appended to the end of a sentence that explains the processing corresponds to the number of a representative sequence schematically illustrated in FIG. 6.

Referring to FIG. 6, the communication terminal 31-1 transmits an ARP request (packet) for MAC address resolution of the communication terminal 32 in order to transmit a packet to the communication terminal 32 (1). The IP address of the communication terminal 32 is set in the destination IP address of this ARP request (packet).

Upon reception of the packet of the ARP request, the packet forwarding function 21 transmits a new flow occurrence notification message to the path control function 10 (2), because the flow of the ARP request packet is a new flow. The packet forwarding function 21 thereby requests the path control function 10 to perform path setting for the received ARP request packet.

The path control function 10 confirms that the ARP request is an ARP request for MAC address resolution within the same subnet based on the followings:

a destination MAC address of a header of the packet in the new flow occurrence notification message is a broadcast address, the packet including an ARP request frame; and

a destination IP address of the ARP request frame is not the IP address of the default gateway. The path control function 10 determines a logical network to which broadcasting is to be performed.

The following describes a logic for determining the logical network to which broadcasting is to be performed with reference to FIG. 7. Steps S1 and S2 are as described before. That is, when the path control function 10 determines execution of broadcasting processing of a packet is necessary (S1), the path control function 10 searches the routing management information table in FIG. 4A for an entry with respect to the subnet targeted for the broadcasting (S2). Herein, the subnet (subnet #B) targeted for the broadcasting to be searched this time is the global subnet. Thus, an entry of the logical network 41 and the logical network 42 associated with the subnet #B is present in the routing management information table in FIG. 4A (Yes branch of S3).

The path control function 10 determines that the logical network to which the broadcasting is to be performed comprises the “logical network 41” and the “logical network 42” associated with the entry of the “subnet #B” in the routing management information table in FIG. 4A.

Referring again to FIG. 6, when the logical networks to which the broadcasting is to be performed are determined, the path control function 10 refers to the logical network management information table in FIG. 3A to transmit a packet forwarding instruction message to each of the packet forwarding functions 22 and 23 respectively connected to the logical networks 41 and 42 (3-1, 3-2).

The packet forwarding function 22 that has received the packet forwarding instruction message from the path control function 10 broadcasts the ARP request to the logical network 42 (transmits the ARP request to the communication terminal 31-2 other than the communication terminal 31-1 of a transmission source)(4-1). The packet forwarding function 23 that has received the packet forwarding instruction message from the path control function 10 broadcasts the ARP request to the logical network 42 (4-2). Upon reception of the new flow occurrence notification from the packet forwarding function 21 in sequence 2, the path control function 10 registers the location information of the communication terminal 31-1 in the location information management table in FIG. 3B.

Upon reception of the ARP request from the packet forwarding function 23, the communication terminal 32 transmits in unicast an ARP reply (packet) with the MAC address of the communication terminal 32 set therein to the packet forwarding function 23, as a reply to the ARP request (5). That is, the communication terminal 32, upon reception of the ARP request from the packet forwarding function 23, sets the MAC address of the communication terminal 32 in the ARP reply (packet) and transmits the ARP reply (packet), because the destination IP address (IP#B-3) specified in the ARP request is identical to the IP address of the communication terminal 32. On the other hand, even when the communication terminal 31-2 receives the ARP request from the packet forwarding function 22, the communication terminal 31-2 does not transmit an ARP reply, because the destination IP address specified in the ARP request is different from the IP address of the communication terminal 31-2.

The packet forwarding function 23, upon reception of the ARP reply from the communication terminal 32, transmits a new flow occurrence notification message to the path control function 10 (6), because the flow of the ARP reply packet is a new flow for which a processing rule has not been set as a packet forwarding rule. The packet forwarding function 23 transmits the path control function 10 the new flow occurrence notification message, thereby requesting the path control function 10 to perform path setting for the received ARP reply packet.

Using the location management information table in FIG. 3B, the path control function 10 recognizes the location information on the destination MAC address (in this case, the packet forwarding function 23 connected to the communication terminal 32 and port number 1 of the port of the packet forwarding function 23 connected to the communication terminal 32) set in the received ARP reply packet. The path control function 10 transmits a packet forwarding instruction message including the ARP reply to the packet forwarding function 21 (8). The packet forwarding function 21 forwards the ARP reply to the communication terminal 31-1. Herein, the path control function 10 may transmit a path setting instruction message to each of the packet forwarding functions 21, 22, and 23 (7-1, 7-2, and 7-3) to set a path for forwarding the ARP reply so that the ARP reply to be subsequently transmitted does not pass through the path forwarding function 10. When the packet control function 10 receives the new flow occurrence notification message from the packet forwarding function 23 (6), the path control function 10 registers the location information of the communication terminal 32 as well in the location management information table in FIG. 3B.

The communication terminal 31-1, upon reception of the ARP reply packet transmitted from the packet forwarding function 21, when it is confirmed that a MAC address of the communication terminal 32 is resolved, transmits a data packet (with the MAC address of the communication terminal 32 set as a packet header destination) to the communication terminal 32 (10).

When the packet forwarding function 21 receives the data packet from the communication terminal 31-1, the packet forwarding function 21 transmits a new flow occurrence notification message to the path control function 10 (11) because the flow of the data packet is a new flow. The packet forwarding function 21 thereby requests the path control function 10 to perform path setting for the received data packet.

The path control function 10 recognizes the location information on the destination MAC address of the received packet (packet forwarding function 23 and port number 1 of the port of the packet forwarding function 23), using the location information management table in FIG. 3B. The path control function 10 transmits a packet forwarding instruction message for the data packet to the packet forwarding function 21 (13). The path control function 10 transmits a path setting instruction to each of the packet forwarding functions 21, 22, and 23 (12-1, 12-2, and 12-3) so that the packet to be subsequently transmitted does not pass through the path control function 10, thereby setting a packet forwarding rule.

The packet forwarding function 21 forwards the data packet received from the communication terminal 31-1 in sequence 10 to the communication terminal 32 through the packet forwarding function 22 and the packet forwarding function 23 (14). Thereafter, data packet forwarding is performed between the communication terminals 31-1 and 32 (15).

With the above-mentioned processing, the communication within the global subnet associated with the plurality of the logical networks is implemented.

In this exemplary embodiment, the description has been directed to the example where a set of each packet forwarding function and the number of the port of the packet forwarding function is used as information constituting a port group managed by the path control function 10. A VLAN (Virtual Local Area Network) may be added to each set of the packet forwarding function and the port number, for management. The VLAN may be a port-based VLAN, for example, in which grouping is performed for each port of a layer 2 switch and an ID (identification information) is given to each port. In the present embodiment, IPv4 (IP Version 4) has been assumed as an IP address version. It is noted that similar processing can be performed using IPv6 (IP Version 6) as well.

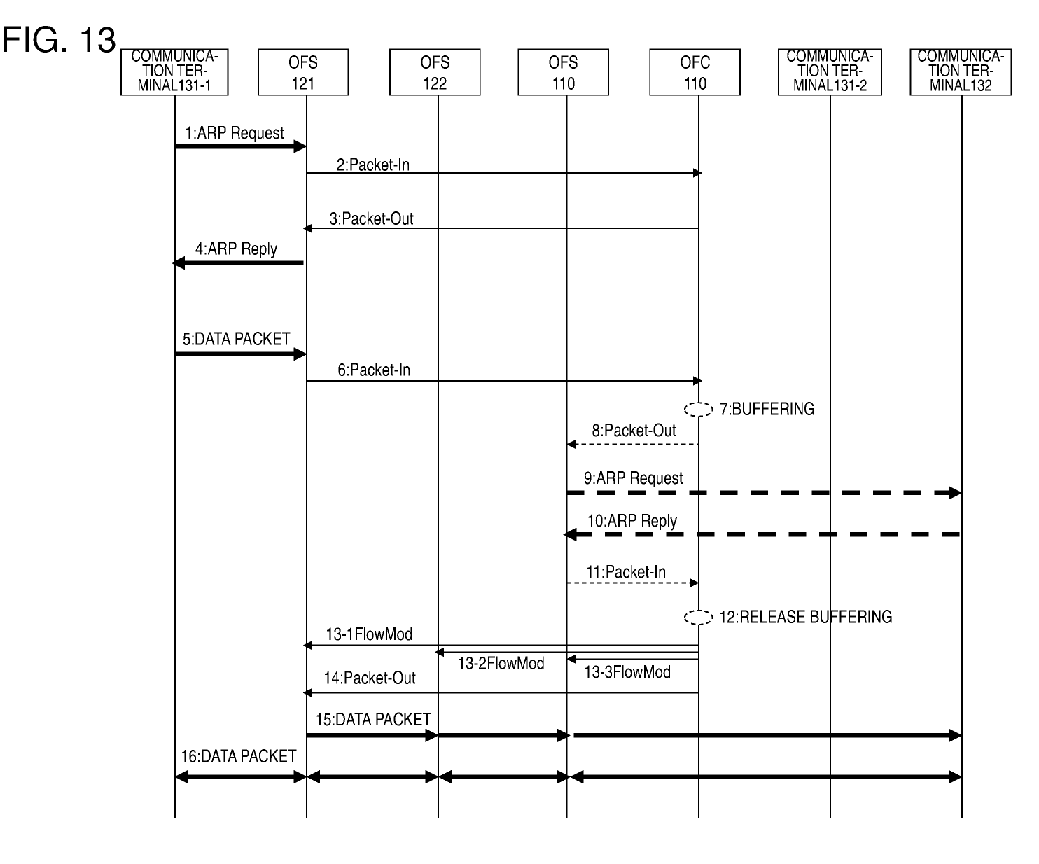

In the present exemplary embodiment, the description has been directed to the example where the communication terminal transmits a broadcast packet. Similar processing can be performed if the path control function 10 can recognize necessity of packet broadcasting. As the other method of recognizing necessity of packet broadcasting by the path control function 10, an example can be pointed out where the path control function 10 generates a broadcast packet by itself, as in transmission of the ARP request in the sequence of sequence number 9 in FIG. 13 or the like. In the example in FIG. 13, the OFC 110 corresponding to the path control function 10 in FIG. 1 includes the ARP request generated by the OFC 110 in the Packet-Out message and transmits the Packet-Out message to the OFS 123 (8). The OFS 123 transmits the ARP request received through the Packet Out message to the communication terminal 132.

As explained in the above-mentioned exemplary embodiment, it is so configured that the routing information table is searched using the network address (subnet). Then, it is so configured that when an entry is present, broadcasting is performed to a group of one or more of the logical networks included in the entry. Restriction to communication between the logical networks or communication within the logical network due to network address (subnet) assignment or the like, which has been described as the problem of the related arts, can be thereby removed. Communication flexibility can be thereby increased.

The above description has been directed to each exemplary embodiment of the present invention. The present invention, is not however limited to the above-mentioned exemplary embodiments. Further variation, substitution, and adjustment can be added. Each disclosure of the above-listed Patent Literature and the above-listed Non Patent Literatures is incorporated herein by reference. Modification and adjustment of each exemplary embodiment are possible within the scope of the overall disclosure (including the claims) of the present invention and based on the basic technical concept of the present invention. Various combinations and selections of various disclosed elements are possible within the scope of the claims of the present invention. That is, the present invention naturally includes various variations and modifications that could be made by those skilled in the art according to the overall disclosure including the claims and the technical concept.

### REFERENCE SIGNS LIST

10 path control function
10A control apparatus
11 node communication unit
12 control message processing unit
13 path and action calculation unit
14 packet forwarding function management unit
15 topology management unit
16 communication terminal location management unit
17A packet forwarding rule management unit
17B packet forwarding rule database (DB)
18 logical network management unit
19 routing management unit
20A communication apparatus
21˜23 packet forwarding function
31-1, 31-2, 32 communication terminal
40A, 41-42 logical network
101 processing rule generation and setting unit 102 broadcasting target logical network determination unit
103 logical network management information storage and management unit
104 network address and logical network correspondence storage and management unit
110 OpenFlow Controller (OFC)
120 flow entry
121˜123 OpenFlow Switch (OFS)
131-1, 131-2, 132 communication terminal
141˜142 logical network
201 processing rule
202 broadcasting transmitting unit

What is claimed is:

1. A communication system comprising:
a control apparatus configured to generate a processing rule that defines packet processing in a communication apparatus and set the generated processing rule in the communication apparatus; and
the communication apparatus configured to process a received packet according to the processing rule set by the control apparatus, wherein
the control apparatus includes:
a first storage and management unit configured to store and manage a logical network to which the communication apparatus is connected;
a second storage and management unit configured to store and manage a correspondence between a network address and a logical network to which the network address is assigned; and
a determination unit configured to determine one or more logical networks for broadcasting targets, based on a correspondence relationship between the network address and the logical network stored in the second store and management unit; and
wherein the determination unit of the control apparatus identifies one or more communication apparatuses connected to the determined one or more logical networks, by referring to the first storage and management unit with respect to the determined one or more logical networks, and sets the one or more communication apparatuses to perform broadcast transmission to the determined one or more logical networks.

2. The communication system according to claim 1, wherein
when an entry that defines a correspondence between a given network address and one or more logical networks is present in the second storage and management unit, the determination unit of the control apparatus determines one or more logical networks associated with the network address defined in the entry, as the one or more logical networks for broadcasting targets.

3. The communication system according to claim 1, wherein
when the entry that defines the correspondence between the given network address and the one or more logical networks is not present in the second storage and management unit, the determination unit of the control apparatus determines a logical network to which a transmission source of a broadcasting request belongs, as a logical network for broadcasting target.

4. The communication system according to claim 1, wherein
with respect to a network address assigned in common to a plurality of the different logical networks included in the communication system, the second storage and management unit of the control apparatus stores a correspondence between the plurality of the different logical networks having the network address in common and the common network address, as one entry.

5. The communication system according to claim 1, wherein
when information of a predetermined address included in a packet to be broadcasted is different from information of an address of a node that serves as a gateway for a logical network different from the logical network to which a transmission source of a broadcasting request belongs, the determination unit of the control apparatus determines the one or more logical networks for broadcasting targets, based on the correspondence relationship between the network address and the logical network.

6. A control apparatus configured to generate a processing rule that defines packet processing in a communication apparatus and set the generated processing rule in the communication apparatus, wherein the control apparatus comprises:
a first unit configured to store and manage a logical network to which the communication apparatus is connected;
a second unit configured to store and manage a correspondence between a network address and the logical network to which the network address is assigned; and
a third unit configured to determine one or more logical networks for broadcasting targets, based on a correspondence relationship between the network address and the logical network stored in the second unit; and
wherein the third unit executes control to identify one or more communication apparatuses connected to the determined one or more logical networks by referring to the first unit with respect to the determined one or more logical networks and cause the one or more communication apparatuses to perform broadcast transmission to the determined one or more logical networks.

7. The control apparatus according to claim 6, wherein
when an entry that defines a correspondence between a given network address and one or more logical networks is present in the second unit, the third unit determines the one or more logical networks associated with the network address defined in the entry, as one or more logical networks for broadcasting targets.

8. The control apparatus according to claim 6, wherein
with respect to a network address assigned in common to a plurality of different logical networks, the second unit stores a correspondence between the plurality of different logical networks having the network address in common and the common network address, as one entry.

9. A communication method by a control apparatus configured to generate a processing rule that defines packet processing in a communication apparatus and set the generated processing rule in the communication apparatus, the communication method comprising:
storing and managing, in a first storage unit, a logical network to which the communication apparatus is connected;
storing and managing, in a second storage unit, a correspondence between a network address and the logical network to which the network address is assigned;
determining one or more logical networks for broadcast targets, based on a correspondence relationship between the network address and the logical network stored in the second storage unit; and
identifying one or more communication apparatuses connected to the determined one or more logical networks, by referring to the first storage unit with respect to the determined one or more logical networks and setting the one or more communication apparatuses to perform broadcast transmission to the determined one or more logical networks.

10. A non-transitory computer-readable storage medium storing therein a program for a computer constituting a control apparatus configured to generate a processing rule that defines packet processing in a communication apparatus and set the generated processing rule in the control apparatus, the program causing the computer to execute the processing comprising:
storing and managing in a first storage unit information of a logical network to which the communication apparatus is connected;
storing and managing in a second storage unit a correspondence between a network address and the logical network to which the network address is assigned;
determining one or more logical networks for broadcasting targets, based on a correspondence relationship between the network address and the logical network stored in the second storage unit; and
one or more communication apparatuses connected to the determined one or more logical networks by referring to the first storage unit with respect to the determined one or more logical networks and setting the one or more communication apparatuses to perform broadcast transmission to the determined one or more logical networks.

11. The control apparatus according to claim 6, wherein
when the entry that defines the correspondence between the given network address and the one or more logical networks is not present in the second unit, the third unit determines a logical network to which a transmission source of a broadcasting request belongs, as a logical network for broadcasting target.

12. The control apparatus according to claim 6, wherein
when information of a predetermined address included in a packet to be broadcasted is different from information of an address of a node that serves as a gateway for a logical network different from the logical network to which the broadcast request source belongs, the third unit determines the one or more logical networks for broadcasting targets, based on the correspondence relationship between the network address and the logical network.

13. The communication method according to claim 9, comprising:
when an entry that defines a correspondence between a given network address and one or more logical networks is present in the second storage unit,
determining one or more logical networks associated with the network address defined in the entry, as the one or more logical networks for broadcasting targets.

14. The communication method according to claim 9, comprising:
when the entry that defines the correspondence between the given network address and the one or more logical networks is not present in the second storage unit,
determining a logical network to which a transmission source of a broadcasting request belongs, as a logical network for broadcasting target.

15. The communication method according to claim 9, comprising:
with respect to a network address assigned in common to a plurality of the different logical networks included in a communication system,
storing, in the second storage unit, a correspondence between the plurality of the different logical networks having the network address in common and the common network address, as one entry.

16. The communication method according to claim 9, comprising:
when information of a predetermined address included in a packet to be broadcasted is different from information of an address of a node that serves as a gateway for a logical network different from the logical network to which a transmission source of a broadcasting request belongs,
determining the one or more logical networks for broadcasting targets, based on the correspondence relationship between the network address and the logical network.

17. The storage medium according to claim 10, storing the program therein to cause the computer to execute the processing comprising:
when an entry that defines a correspondence between a given network address and one or more logical networks is present in the second storage unit,
determining one or more logical networks associated with the network address defined in the entry, as the one or more logical networks for broadcasting targets.

18. The storage medium according to claim 10, storing the program therein to cause the computer to execute the processing comprising:
when the entry that defines the correspondence between the given network address and the one or more logical networks is not present in the second storage unit,
determining a logical network to which a transmission source of a broadcasting request belongs, as a logical network for broadcasting target.

19. The storage medium according to claim 10, storing the program therein to cause the computer to execute the processing comprising:
with respect to a network address assigned in common to a plurality of the different logical networks included in a communication system,
storing, in the second storage unit, a correspondence between the plurality of the different logical networks having the network address in common and the common network address, as one entry.

20. The storage medium according to claim 10, storing the program therein to cause the computer to execute the processing comprising:
when information of a predetermined address included in a packet to be broadcasted is different from information of an address of a node that serves as a gateway for a logical network different from the logical network to which a transmission source of a broadcasting request belongs,
determining the one or more logical networks for broadcasting targets, based on the correspondence relationship between the network address and the logical network.
